(19) United States
(12) Patent Application Publication
(10) Pub. No.: US 2015/0337403 A1
(43) Pub. Date: Nov. 26, 2015

(54) PLANT-BIOMASS HYDROLYSIS METHOD

(71) Applicants: SHOWA DENKO K.K., Tokyo (JP); NATIONAL UNIVERSITY CORPORATION HOKKAIDO UNIVERSITY, Sapporo-shi, Hokkaido (JP)

(72) Inventors: Ichiro FUJITA, Tokyo (JP); Tadashi YONEDA, Tokyo (JP); Atsushi FUKUOKA, Sapporo-shi, Hokkaido (JP); Hirokazu KOBAYASHI, Sapporo-shi, Hokkaido (JP); Mizuho YABUSHITA, Sapporo-shi, Hokkaido (JP)

(73) Assignees: SHOWA DENKO K.K., Tokyo (JP); NATIONAL UNIVERSITY CORPORATION HOKKAIDO UNIVERSITY, Sapporo-shi, Hokkaido (JP)

(21) Appl. No.: 14/653,139

(22) PCT Filed: Nov. 19, 2013
(86) PCT No.: PCT/JP2013/081183

§ 371 Date: Jun. 17, 2015

(30) Foreign Application Priority Data
Dec. 18, 2012 (JP) 2012-275515

(51) Int. Cl. C13K 1/02

(52) U.S. Cl. CPC C13K 1/02

(57) ABSTRACT

A method for hydrolyzing a plant biomass, which includes hydrothermal treatment in the presence of an equivalent concentration of an acid equal to 30 to 1,000% of the equivalent concentration of cations in a plant-biomass hydrolysis reaction solution; and a method for producing glucose using the above method for hydrolyzing a plant biomass. The hydrothermal treatment is preferably conducted by using a solid catalyst comprising a carbon material and using inorganic acid as acid. The method eliminates reaction-inhibiting factors to thereby obtain a high glucose yield.

### TECHNICAL FIELD

The present invention relates to a method of hydrolyzing a plant biomass. Particularly, the present invention relates to a hydrolysis method in which factors inhibiting the hydrolysis reaction by hydrothermal treatment of a plant biomass are eliminated and high glucose yield can be obtained.

### BACKGROUND ART

In recent years, many studies have been made on use of useful substances converted from recyclable biomass resources produced from plants and the like. Cellulose contained in a plant biomass as a main component is a polymer formed of β-1,4-linked glucose units. Since the cellulose forms hydrogen bonds within and between molecules and exhibits high crystallinity, the cellulose is characterized in being insoluble in water or a usual solvent and being persistent. In recent years, a study on a reaction which can reduce an environmental burden has been made as a cellulose hydrolysis method instead of a sulfuric acid method or an enzyme method.

For example, JP H10-327900 A (Patent Document 1) discloses a method of hydrolyzing cellulose powder by bringing it into contact with hot-water under pressure heated to 200 to 300° C. (hydrolysis method by hydrothermal treatment). JP 2009-201405 A (Patent Document 2) discloses a method using an activated carbon solid acid catalyst subjected to sulfuric acid treatment as the solid catalyst in the hydrothermal reaction. Furthermore, JP 2011-206044 A (Patent Document 3) discloses a method which enables a glucose yield of 60% or more by bringing a raw material containing cellulose and an aqueous solution containing an inorganic acid into contact with each other, followed by heating and pressure treatment. However, these patent documents only describe an example using genuine cellulose as a raw material and do not mention the inhibitory influence due to impurities in the case of treating an actual biomass or a method for eliminating the influence.

In order to improve the practical utility of the saccharification technology by hydrothermal treatment, it is necessary to establish technology which can be applied to an actual biomass material.

In the case of saccharifying an actual biomass material by hydrothermal treatment, pretreatment using a chemical agent such as a delignification agent is performed to suppress the decrease in saccharification efficiency or decrease in the purity of the sugar solution to be obtained, which are caused due to a non-cellulose component such as hemicellulose, lignin and ash contained in an actual biomass. The product after the pretreatment is subjected to solid-liquid separation and the resultant insoluble residue is subjected to hydrothermal treatment.

The hydrothermal treatment places a burden of separation and refinement to remove soluble impurities by washing the residues with a large amount of water in order to suppress the decrease in the hydrolysis reaction caused by the insoluble impurities remained in the insoluble residues.

As described above, there has been a demand for establishment of a method for saccharifying cellulose in a hydrolysis reaction of a plant biomass through a hydrothermal reaction, in which inhibition of reaction due to coexisting impurities has been eliminated and a high glucose yield can be attained.

### PRIOR ART

### Patent Document

Patent Document 1: JP H10-327900 A

Patent Document 2: JP 2009-201405 A

Patent Document 3: JP 2011-206044 A

### DISCLOSURE OF THE INVENTION

### Problems to be Solved by the Invention

An objective of the present invention is to provide a method of hydrolyzing a plant biomass, which can attain a high glucose yield by eliminating reaction-inhibiting factors.

### Means to Solve the Problem

The present inventors made intensive studies to achieve the above objective. As a result, the present inventors have found that reaction-inhibiting factors can be eliminated and a high glucose yield can be attained by adding acid to the reaction solution according to the equivalent concentration of cations in the reaction solution, and have accomplished the present invention.

That is, the present invention provides a method for hydrolyzing a plant biomass in the following [1] to [9] and a method for producing glulose in the following [10].

[1] A method for hydrolyzing a plant biomass, comprising hydrothermal treatment in the presence of an equivalent concentration of an acid equal to 30 to 1,000% of the equivalent concentration of cations in a plant-biomass hydrolysis reaction solution.
[2] The method for hydrolyzing a plant biomass according to [1] above, wherein a solid catalyst is used in the hydrothermal treatment.
[3] The method for hydrolyzing a plant biomass according to [1] or [2] above, wherein the acid is at least one member selected from inorganic mineral acid, organic carbonic acid and organic sulfonic acid.
[4] The method for hydrolyzing a plant biomass according to any one of [1] to [3] above, wherein the cation in the reaction solution is at least one member selected from alkali metal ion, alkaline earth metal ion and ammonium ion.
[5] The method for hydrolyzing a plant biomass according to any one of [1] to [4] above, wherein the equivalent concentration of the acid is 100 to 300% of the equivalent concentration of cations in a plant-biomass hydrolysis reaction solution.
[6] The method for hydrolyzing a plant biomass according to any one of [2] to [5] above, wherein the solid catalyst is a carbon material.
[7] The method for hydrolyzing a plant biomass according to any one of [3] to [6] above, wherein the inorganic mineral acid is at least one member selected from hydrochloric acid, sulfuric acid, nitric acid, phosphoric acid and boric acid.
[8] The method for hydrolyzing a plant biomass according to any one of [1] to [7] above, wherein the cation in the reaction solution is at least one member selected from Na⁺, K⁺, Mg²⁺, Ca²⁺ and NH₄₊.
[9] The method for hydrolyzing a plant biomass according to any one of [1] to [8] above, wherein the plant biomass is cellulose.
[10] A method for producing glucose, characterized in using the method for hydrolyzing a plant biomass described in any one of [1] to [9] above.

### Effects of the Invention

According to the method for hydrolyzing a plant biomass of the present invention, the cations in the hydrolysis reaction solution as being a reaction-inhibiting factor can be eliminated and a high glucose yield can be attained.

### BRIEF DESCRIPTION OF DRAWINGS

FIG. 1 shows a change in the product yield by comparing the cases with or without the addition of a carbon catalyst, when Na₂SO₄ and sulfuric acid are added as a reaction-inhibiting agent and as an inhibitor-eliminating agent, respectively, in the hydrolysis reaction of separately pulverized materials.

FIG. 2 shows a change in the product yield when Na₂SO₄ and (NH₄)₂SO₄ are added in different concentrations as a reaction-inhibiting agent in the hydrolysis reaction of separately pulverized materials using a carbon catalyst.

FIG. 3 shows a change in the product yield when Na₂SO₄ is added as a reaction-inhibiting agent and sulfuric acid, hydrochloric acid or nitric acid is added as an inhibitor-eliminating agent in the hydrolysis reaction of separately pulverized materials using a carbon catalyst.

FIG. 4 shows a change in the product yield when ammonium sulfate and sulfuric acid are added as a reaction-inhibiting agent and as an inhibitor-eliminating agent, respectively, in the hydrolysis reaction of separately pulverized materials using a carbon catalyst. In the figure, the black portion, vertical-stripe portion, shaded portion, white portion indicate the yield of glucose, yield of sugar other than glucose, yield of an excessive degradation product, and yield of an unknown product, respectively.

### MODE FOR CARRYING OUT THE INVENTION

The present invention is hereinafter described in detail. The method for hydrolyzing a plant biomass of the present invention is characterized in eliminating the cations in the reaction solution having inhibitory influence on the reaction by allowing acid to coexist in the reaction solution.

[Plant Biomass (Solid Substrate)]

The term “biomass” generally refers to “recyclable organic resource of biologic origin, excluding fossil resources.” In the present description, the “plant biomass” is, for example, a biomass such as rice straw, wheat straw, sugarcane leaves, chaff, bagasse, a broadleaf tree, bamboo, a coniferous tree, kenaf, furniture waste wood, construction waste wood, waste paper, or a food residue, which mainly contains cellulose or hemicellulose. In the present invention, a plant biomass is used as a solid substrate in the hydrolysis reaction.

As a solid substrate, a plant biomass may be used as it is. Or a plant biomass to be used may be one that is obtained by subjecting the plant biomass to treatment such as alkali steam treatment, alkaline sulfite steam treatment, neutral sulfite steam treatment, alkaline sodium sulfide steam treatment, ammonia steam treatment, sulfuric acid steam treatment and water-vapor steam treatment, and then to treatment to decrease the lignin content and hemicellulose content by performing the operations of neutralization, washing with water, dehydration and drying, and that contains two or more members out of cellulose, hemicellulose, and lignin. Further, the plant biomass may be industrially prepared cellulose, xylan, cellooligosaccharide, or xylooligosaccharide. The plant biomass may contain an ash content such as silicon, aluminum, calcium, magnesium, potassium, or sodium, which is derived from the plant biomass, as an impurity.

The plant biomass may be in a dry form or a wet form, and may be crystalline or non-crystalline. The size of the plant biomass is not particularly limited as long as the pulverization treatment of the biomass can be performed. From the viewpoint of the pulverization efficiency, a particle diameter is preferably 20 μm or more and several thousand micrometers or less.

[Solid Catalyst]

In the hydrolysis method by hydrothermal treatment of the present invention, a solid catalyst may be used. The solid catalyst is not particularly limited as long as the catalyst can hydrolyze the plant biomass, but preferably has an activity to hydrolyze a glycoside bond typified by β-1,4 glycosidic bonds between glucose units that form cellulose contained as a main component.

Examples of the solid catalyst include a carbon material and a transition metal. One kind of those solid catalysts may be used alone, or two or more kinds thereof may be used in combination.

Examples of the carbon material include activated carbon, carbon black, and graphite. One kind of those carbon materials may be used alone, or two or more kinds thereof may be used in combination. Regarding the shape of the carbon material, from the viewpoint of improving reactivity by increasing an area for contact with a substrate, the carbon material is preferably porous and/or particulate. From the viewpoint of promoting hydrolysis by expressing an acid site, the carbon material preferably has a surface functional group such as a phenolic hydroxyl group, a carboxyl group, a sulfonyl group, or a phosphate group. Examples of a porous carbon material having a surface functional group include a wood material such as coconut husk, bamboo, pine, walnut husk, or bagasse; and activated carbon prepared by a physical method involving treating coke or phenol at high temperature with a gas such as steam, carbon dioxide or air, or by a chemical method involving treating coke or phenol at high temperature with a chemical reagent such as an alkali or zinc chloride. Specifically, activated carbon such as a porous alkali-activated carbon material can be used.

A transition metal selected from the group consisting of ruthenium, platinum, rhodium, palladium, iridium, nickel, cobalt, iron, copper, silver and gold may be used singly or two or more thereof may be used in combination. One selected from platinum group metals including ruthenium, platinum, rhodium, palladium, and iridium is preferred from the viewpoint of having a high catalytic activity, and one selected from ruthenium, platinum, palladium, and rhodium is particularly preferred from the viewpoints of having a high rate of conversion of cellulose and selectivity of glucose.

[Pulverization of a Solid Substrate]

Cellulose, which is a main component of polysaccharides contained in a plant biomass, exhibits crystallinity, because two or more cellulose molecules are bonded to each other through hydrogen bonding. In the present invention, such cellulose exhibiting crystallinity may be used as a raw material, but cellulose that is subjected to treatment for reducing crystallinity and thus has reduced crystallinity may be used. As the cellulose having reduced crystallinity, cellulose in which the crystallinity is partially reduced or cellulose in which the crystallinity is completely or almost completely lost may be used. The kind of the treatment for reducing crystallinity is not particularly limited, but treatment for reducing crystallinity capable of breaking the hydrogen bonding and at least partially generating a single-chain cellulose molecule is preferably employed. By using as the raw material cellulose at least partially containing the single-chain cellulose molecule, hydrolysis efficiency can be significantly improved.

As a method of breaking the hydrogen bonding between cellulose molecules, there is given, for example, pulverization treatment. The pulverization means is not particularly limited as long as the means has a function to enable fine pulverization. For example, the mode of the apparatus may be a dry mode or a wet mode. In addition, the pulverization system of the apparatus may be a batch system or a continuous system. Further, as a pulverization apparatus, an apparatus using the pulverizing force provided by impact, compression, shearing, friction and the like can be used.

Specific examples of the apparatus for pulverization include: tumbling ball mills such as a pot mill, a tube mill, and a conical mill; vibrating ball mills such as a circular vibration type vibration mill, a rotary vibration mill, and a centrifugal mill; mixing mills such as a media agitating mill, an annular mill, a circulation type mill, and a tower mill; jet mills such as a spiral flow jet mill, an impact type jet mill, a fluidized bed type jet mill, and a wet type jet mill; shear mills such as a Raikai mixer and an angmill; colloid mills such as a mortar and a stone mill; impact mills such as a hammer mill, a cage mill, a pin mill, a disintegrator, a screen mill, a turbo mill, and a centrifugal classification mill; and a planetary ball mill as a mill of a type that employs rotation and revolution movements.

In the hydrolysis using a solid catalyst, a rate of the reaction is limited by the degree of contact between the solid substrate and the solid catalyst. Therefore, as a method of improving reactivity, preliminarily mixing the solid substrate and the solid catalyst, followed by pulverizing the mixture simultaneously (hereinafter referred to as “simultaneous pulverization treatment”), is an effective way.

The simultaneous pulverization treatment may include pre-treatment for reducing the crystallinity of the substrate in addition to the mixing. From such viewpoint, the pulverization apparatus is preferably a tumbling ball mill, a vibrating ball mill, a mixing mill, or a planetary ball mill, which is used for the pre-treatment for reducing the crystallinity of the substrate, more preferably a pot mill classified as the tumbling ball mill, a media agitating mill classified as the mixing mill, or the planetary ball mill. Further, the reactivity tends to increase when a raw material obtained by the simultaneous pulverization treatment for the solid catalyst and the solid substrate has a high bulk density. Therefore, it is more preferred to use the tumbling ball mill, the mixing mill, or the planetary ball mill that can apply a strong compression force enough to allow a pulverized product of the solid catalyst to dig into a pulverized product of the solid substrate.

A ratio between the solid catalyst and the solid substrate to be subjected to the simultaneous pulverization treatment is not particularly limited. From the viewpoints of hydrolysis efficiency in a reaction, a decrease in a substrate residue after the reaction, and a recovery rate of a produced sugar, the mass ratio between the solid catalyst and the solid substrate is preferably 1:100 to 1:1, more preferably 1:10 to 1:1.

In each of the raw material obtained by separately pulverizing the substrate and the raw material obtained by simultaneously pulverizing the substrate and the catalyst, the average particle diameter after the fine pulverization (median diameter: particle diameter at a point where the cumulative volume curve determined based on the total powder volume defined as 100% crosses 50%) is from 1 to 100 μm, preferably from 1 to 30 μm, more preferably from 1 to 20 μm from the viewpoint of improving reactivity.

For example, when the particle diameter of a raw material to be treated is large, in order to efficiently perform the pulverization, preliminary pulverization treatment may be performed before the fine pulverization with, for example: a coarse crusher such as a shredder, a jaw crusher, a gyratory crusher, a cone crusher, a hammer crusher, a roll crusher or a roll mill; or a medium crusher such as a stamp mill, an edge runner, a cutting/shearing mill, a rod mill, an autogenous mill or a roller mill. The time for treating the raw material is not particularly limited as long as the raw material can be homogeneously and finely pulverized by the treatment.

[Determination of the Concentration of Cations]

The present invention is based on the finding that the hydrolysis of a plant biomass is inhibited when cations exist in the reaction solution to thereby lower the conversion and glucose saccharification rate, and the finding that the inhibition can be eliminated by adding a specific amount of acid to the reaction solution according to the equivalent concentrations of the cations.

The cations in the reaction solution in the present invention are alkali metal ions, alkaline earth metal ions, ammonium ions and the like derived from the plant biomass as a raw material and a solid catalyst and/or from an alkaline agent used in the pretreatment of the hydrolysis reaction. K⁺, Na⁺, Mg²⁺, Ca²⁺ and NH₄⁺ accounts for the majority of the cations in many cases.

The equivalent concentration of the cations in the reaction solution can be comprehensively determined from the measurement results by ion chromatography, indophenol blue absorptiometry, inductively-coupled plasma (ICP), electron probe microanalyzer (EPMA), electron spectroscopy for chemical analysis (ESCA), secondary ion mass spectrometry (SIMS) and atomic absorption spectrophotometry. It is preferable to use ion chromatography because it enables direct and high-sensitivity measurement of the main cations in the reaction solution at once. The equivalent concentration of the cations is based on the value just before the hydrothermal reaction, and a bivalent cation is counted twice as much as a monovalent cation.

[Acid]

As an acid, inorganic mineral acid such as hydrochloric acid, sulfuric acid, nitric acid, phosphoric acid and boric acid; organic carboxylic acid such as acetic acid, formic acid, phthalic acid, lactic acid, malic acid, fumaric acid, citric acid and succinic acid; organic sulfonic acid such as methane sulfonic acid, ethane sulfonic acid, benzene sulfonic acid and toluene sulfonic acid; may be used alone or two or more thereof in combination. Among these, inorganic mineral acid is preferable because the acid per se is less likely to be decomposed and deteriorated during hydrothermal treatment, and has less inhibitory effect at the time of using sugar as an objective product, and sulfuric acid, hydrochloric acid and nitric acid are more preferable.

The lower limit and upper limit of the acid concentration can be set from the viewpoints of facilitating rapid recovery of the glucose saccharification rate, and suppressing the excessive degradation of glucose and the acid corrosion, respectively. It is desirable to allow acid in the reaction solution in the equivalent concentration in the same range of 30 to 1,000%, preferably 50 to 500%, more preferably 100 to 300% of the equivalent concentration of the cations in the reaction solution.

[Hydrolysis Reaction (Hydrothermal Treatment)]

The hydrolysis using a plant biomass as a solid substrate is performed by hydrothermal treatment. The hydrothermal treatment is conducted by heating the substrate under the presence of water, preferably with the addition of a solid catalyst, at a temperature that allows for a pressurized state. As the heating temperature that allows for a pressurized state, for example, a range of from 110 to 380° C. is appropriate. In the case where the plant biomass is cellulose, a relatively high temperature is preferred from the viewpoint of promptly performing its hydrolysis and suppressing conversion of glucose, which is a product, into another sugar. In this case, for example, it is appropriate to set the maximum heating (reaction) temperature within a range of from 170 to 320° C., more preferably from 180 to 300° C.

The hydrothermal treatment in the hydrolysis method of the present invention is usually carried out in a closed vessel such as an autoclave. Therefore, even if the pressure at the start of the reaction is ordinary pressure, the reaction system becomes a pressurized state when heated at the above-mentioned temperature. Further, the closed vessel may be pressurized before the reaction or during the reaction to perform the reaction. The pressure for pressurization is, for example, from 0.1 to 30 MPa, preferably from 1 to 20 MPa, more preferably from 2 to 10 MPa. In addition to the closed vessel, the reaction liquid may be heated and pressurized to perform the reaction while the reaction liquid is allowed to flow by a high-pressure pump.

The amount of water for hydrolysis is at least one necessary for hydrolysis of the total amount of cellulose and hemicellulose in the plant biomass. In consideration of, for example, fluidity and stirring property of the reaction mixture, the mass ratio between the water and the plant biomass is preferably 1:1 to 500:1, more preferably 2:1 to 200:1.

The atmosphere of the hydrolysis is not particularly limited. From an industrial viewpoint, the hydrolysis is preferably carried out under an air atmosphere, or may be carried out under an atmosphere of gas other than air, such as oxygen, nitrogen, or hydrogen, or a mixture thereof.

From the viewpoint of increasing the yield of glucose, the heating in the hydrothermal treatment is preferably completed at the point when the rate of conversion of cellulose by hydrolysis falls within a range of from 10 to 100% and the selectivity of glucose falls within a range of from 20 to 80%. The point when the rate of conversion of cellulose by hydrolysis falls within a range of from 10 to 100% and the selectivity of glucose falls within a range of from 20 to 80% varies depending on the heating temperature, the type and amount of the catalyst to be used, the amount of water (ratio relative to cellulose), the type of cellulose, the stirring method and conditions, and the like. Therefore, the point may be determined based on an experiment after determination of the conditions. The heating time under usual conditions falls within, for example, a range of from 5 to 60 minutes, preferably from 5 to 30 minutes after the start of the heating for the hydrolysis reaction, but the time is not limited to the range. In addition, the heating for hydrolysis is suitably completed at the point when the rate of conversion of cellulose by hydrolysis falls within a range of preferably from 30 to 100%, more preferably from 40 to 100%, still more preferably from 50 to 100%, most preferably from 55 to 100% and the selectivity of glucose falls within a range of preferably from 25 to 80%, more preferably from 30 to 80%, most preferably from 40 to 80%.

The hydrolysis reaction may be carried out in a batch fashion or a continuous fashion. The reaction is preferably carried out while stirring the reaction mixture.

In the present invention, it is possible to produce a sugar-containing solution that contains glucose as a main component and has a reduced amount of an excessive degradation product such as 5-hydroxymethylfurfural by performing a hydrolysis reaction at a relatively high temperature for a relatively short time.

After completion of heating, the reaction liquid is preferably cooled from the viewpoint of suppressing conversion of glucose into another sugar to increase the yield of glucose. From the viewpoint of increasing the yield of glucose, the cooling of the reaction liquid is carried out under conditions where the selectivity of glucose is maintained in a range of preferably from 20 to 80%, more preferably from 25 to 80%, still more preferably from 30 to 80%, most preferably from 40 to 80%.

From the viewpoint of increasing the yield of glucose, the cooling of the reaction liquid is preferably carried out as fast as possible to a temperature at which conversion of glucose into another sugar is not substantially caused. For example, the cooling may be carried out at a rate in a range of from 1 to 200° C./min and is preferably carried out at a rate in a range of from 5 to 150° C./min. The temperature at which conversion of glucose into another sugar is not substantially caused is, for example, 150° C. or less, preferably 110° C. or less. That is, the reaction liquid is suitably cooled to 150° C. or less at a rate in a range of from 1 to 200° C./min, preferably from 5 to 150° C./min, more suitably cooled to 110° C. or less at a rate in a range of from 1 to 200° C./min, preferably from 5 to 150° C./min.

The obtained reaction solution can be separated into a liquid phase containing glucose and a solid phase containing a solid catalyst and an unreacted substrate by the solid-liquid separation treatment and be recovered. For the solid-liquid separation, an apparatus such as a centrifugal separator, centrifugal filter, press filter, Nutsche filter and filter press can be used, and the apparatus is not particularly limited as long as it can separate a liquid phase and a solid phase.

### EXAMPLES

The present invention is hereinafter described in more details by way of Examples and Comparative Examples. However, the present invention is by no means limited to the descriptions of Examples and Comparative Examples.

[Solid Catalyst]

Coke (coal coke, manufactured by SHOWA DENKO K.K.) was subjected to heating treatment at 700° C., followed by fine pulverization with a jet mill. Then, potassium hydroxide was added thereto, and the resultant was again subjected to heating treatment at 700° C. to be activated. After washed with water, the obtained activated coke was neutralized with hydrochloric acid and further boiled in hot water. After that, the resultant was dried and sieved. Thus, an alkali-activated porous carbon material (median diameter: 13 μm) (hereinafter referred to as a “carbon catalyst”) having a particle diameter of 1 μm or more and 30 μm or less was obtained.

[Solid Substrate]

In each of Examples and Comparative Examples, separately pulverized Avicel (microcrystalline cellulose manufactured by Merck Co.) was used as a reagent-grade solid substrate.

[Separately Pulverized Raw Material]

3.00 g of Avicel serving as a solid substrate was loaded in a 500 ml-volume ceramic pot mill together with 300 g of zirconia balls each having a diameter of 1.5 cm. The ceramic pot mill was set to a desktop pot mill rotating table (manufactured by IRIE SHOKAI Co., Ltd., desktop pot mill type V-1M). The content was pulverized through ball mill treatment at 60 rpm for 48 hours. The obtained raw material is hereinafter referred to as separately pulverized raw material.

[Hydrolysis Reaction (Hydrothermal Treatment)]

Hydrolysis reaction of cellulose was conducted by placing raw materials as described in each of Examples and Comparative Examples in a high-pressure reactor (internal volume: 100 mL, autoclave manufactured by Nitto Koatsu Co., Ltd., made of SUS316), and then, heated from room temperature to a reaction temperature (200° C. to 240° C.) to be investigated while being stirred at 600 rpm for about 20 minutes. Heating was stopped at the time as the temperature reached the reaction temperature, and the reactor was cooled in a water tank. After cooling, the reaction liquid was separated with a centrifuge into a liquid and a solid. The products in the liquid phase were quantitatively analyzed with a high-performance liquid chromatograph (apparatus: high-performance liquid chromatograph Shodex manufactured by SHOWA DENKO K.K., column: Shodex (trademark) KS801, mobile phase: water at 0.6 ml/min., 75° C., detection: differential refractive index). In addition, after drying the solid residues washed with water at 110° C. for 24 hours, the conversion of cellulose was determined based on the mass of the unreacted cellulose.

Equations for calculating the yield of product, conversion of cellulose, selectivity of glucose, and yield of unknown product are shown below.

Yield of product (%)={(molar number of carbon in component of interest)/(molar number of carbon in added cellulose)}×100

Rate of conversion of cellulose (%)={1−(mass of recovered cellulose)/(mass of added cellulose)}×100

Selectivity of glucose (%)={(yield of glucose)/(rate of conversion of cellulose)}×100

Yield of unknown product (%)=rate of conversion of cellulose-total yield of identified components [Equation 1]

[Measurement of pH]

pH was measured after immersing the glass electrodes of the device in a sample solution at 25° C. in a glass bottle, lightly stirring the solution, and allowing to stand until the solution is stabilized (about one minute) using pH meter D-51 (manufactured by HORIBA, Ltd.) in which a three-point calibration is conducted using pH STANDARD 100-4, 100-7 and 100-9 (manufactured by HORIBA, Ltd.).

[Measurement of Cations]

The equivalent concentration of the cations contained in the reaction solution was determined by quantitatively analyzing the supernatant obtained by solid-liquid separation using a centrifugal separator for Na⁺, K⁺, Mg²⁺, Ca²⁺ and NH₄₊ with a high-performance liquid chromatograph (apparatus: high-performance liquid chromatograph Shodex manufactured by SHOWA DENKO K.K., column: Shodex (trademark) IC IK-421, mobile phase: 0.75 g/l of tartaric acid, 1.5 g/l of boric acid and 0.267 g/l of 2,6-pyridine carboxylic acid at 1 ml/min., 40° C., detection: electric conductivity).

### Referential Example 1, Example 1, Comparative Examples 1

### Inhibition of Reaction Due to Cations, and Elimination of the Inhibition by Acid in the Hydrothermal Treatment without the Addition of a Solid Catalyst

0.324 g of the separately pulverized raw material (2.00 mmol in terms of C₆H₁₀O₅) was used to provide 40 ml of an aqueous dispersion having an equivalent concentrations of the inhibitor (Na₂SO₄) and acid (H₂SO₄) adjusted as shown in Table 1. The aqueous dispersion was put in a high-pressure reactor (internal volume: 100 ml, autoclave manufactured by OM LAB-TECH CO., LTD, made of Hastelloy C22), and then, heated from room temperature to a reaction temperature of 200° C. over about 15 minutes while being stirred at 600 rpm. The heating was stopped at the time as the temperature reached the reaction temperature, and the reactor was air-cooled. It took three minutes from when the cooling started to when the temperature reached 150° C. After the cooling, the reaction liquid was separated with a centrifuge into a liquid and a solid. The products in the liquid phase were quantitatively analyzed for glucose, other sugars, and an excessive degradation product with a high-performance liquid chromatograph (apparatus: Shodex high-performance liquid chromatograph manufactured by SHOWA DENKO K.K., column: Shodex (trademark) KS801, mobile phase: water at 0.6 mL/min, 75° C., detection: differential refractive index). In addition, the solid residues were dried at 110° C. for 24 hours and separated into unreacted cellulose and the carbon catalyst. The rate of conversion of cellulose was determined based on the mass of the unreacted cellulose.

As compared to Referential Example 1 with no addition of an inhibitor, Comparative Example 1, in which 1.4 mN of Na₂SO₄ is added, the rate of conversion of cellulose decreased from 33% to 3%, resulting in a relative ratio of 10%, and the glucose yield decreased from 7.1% to 0.5%, resulting in a relative ratio of 7%. From the decrease in both of the glucose yield and the rate of conversion of glucose, it was confirmed that Na₂SO₄ totally inhibits hydrolysis of the substrate itself by the hydrothermal reaction.

In Example 1, Na₂SO₄ and sulfuric acid were added in an equivalent amount so that the both have a concentration of 1.4 mN to thereby conduct the reaction. As compared to Comparative Example 1, the rate of conversion of cellulose increased from 3% to 34% (as high as a relative ratio of 102% to Referential Example 1) and the glucose yield increased from 0.5% to 7.2%, and it was confirmed that the decrease due to the inhibition can be completely eliminated by adding sulfuric acid in an equivalent amount of the inhibitor.

When looking at an inhibiting factor and a factor for eliminating the inhibition in Referential Example 1, Example 1 and Comparative Example 1, the inhibitor is sodium sulfate and the inhibitor-eliminating agent is sulfuric acid. Since the sulfate ion is a common anion to the inhibitor and the inhibitor-eliminating agent and is unlikely to be a component which causes an opposite action, it is considered that cation contributes to the inhibition and proton contributes to the elimination of the inhibition.

TABLE 1
Inhibition of reaction due to cations, and
elimination of the inhibition by acid in the reaction with the
addition of a solid catalyst

| | | | Referential | Comparative | |
|---|---|---|---|---|---|
| | | | Example 1 | Example 1 | Example 1 |
| Conditions | Inhibitor | Kind | | Na₂SO₄ | Na₂SO₄ |
| | | Concentration | | 1.4 | 1.4 |
| | | (Mn) | | | |
| | Acid | Kind | — | — | H₂SO₄ |
| | | Concentration | — | — | 1.4 |
| | | (mN) | | | |
| | | Relative ratio to | — | — | 100 |
| | | the concentration | | | |
| | | of inhibitor (%) | | | |
| | | (a) | | | |
| Results | pH | Before the | 4.2 | 4.3 | 4.3 |
| | | addition of acid | | | |
| | | After the addition | — | — | 2.9 |
| | | of acid | | | |
| | | After the reaction | 3.5 | 3.6 | 2.9 |
| | Product yield (%, | Glucose | 7.1 | 0.5 | 7.2 |
| | on the basis of | Other sugars (b) | 15.9 | 1.2 | 15.3 |
| | carbon) | Excessive | 3.2 | 0.5 | 4.1 |
| | | degradation | | | |
| | | product (c) | | | |
| | | Unknown | 6.9 | 1.1 | 7.2 |
| | Rate of cellulose conversion (%) | | 33 | 3 | 34 |
| | Selectivity of glucose (%) | | 21 | 15 | 21 |
| | Relative ratio to | Glucose yield | 100 | 7 | 101 |
| | Referential | Rate of cellulose | 100 | 10 | 102 |
| | Example 1 (%) | conversion | | | |
| | | Selectivity of | 100 | 71 | 99 |
| | | glucose | | | |

(a) Concentration of inorganic acid: {(mN)/concentration of the inhibitor (mN)} × 100
(b) Total of cellobiose, cellotriose, mannose and fructose
(c) Total of levoglucosan, 5-hydroxymethylfurfural and levoglucosan

### Referential Example 2, Examples 2 to 10, Comparative Examples 2 to 9

### Inhibition Due to Cations, and Elimination of the Inhibition by Acid in the Reaction with the Addition of a Solid Catalyst

0.324 g of the separately pulverized raw material (2.00 mmol in terms of C₆H₁₀O₅) and 0.050 g of a solid catalyst were used to provide 40 ml of an aqueous dispersion having an equivalent concentrations of the inhibitor (Na₂SO₄) and acid (H₂SO₄, HCl or HNO₃) adjusted as shown in Table 2. The aqueous dispersion was put in a high-pressure reactor (internal volume: 100 ml, autoclave manufactured by OM LAB-TECH CO., LTD, made of Hastelloy (trademark) C22), and then, heated from room temperature to a reaction temperature of 200° C. over about 15 minutes while being stirred at 600 rpm. The heating was stopped at the time as the temperature reached the reaction temperature, and the reactor was air-cooled. It took three minutes from when the cooling started to when the temperature reached 150° C. After the cooling, the reaction liquid was separated with a centrifuge into a liquid and a solid. The products in the liquid phase were quantitatively analyzed for glucose, other sugars, and an excessive degradation product with a high-performance liquid chromatograph (apparatus: Shodex high-performance liquid chromatograph manufactured by SHOWA DENKO K.K., column: Shodex (trademark) KS801, mobile phase: water at 0.6 mL/min, 75° C., detection: differential refractive index). In addition, the solid residues were dried at 110° C. for 24 hours and separated into unreacted cellulose and the carbon catalyst. The rate of conversion of cellulose was determined based on the mass of the unreacted cellulose.

Comparison of the hydrolysis behavior was made depending on whether a porous alkali-activated carbon material (a solid catalyst) is added or not. On condition that neither of an inhibitor nor acid is added, in Referential Example 2 in which a solid catalyst is added, the cellulose conversion rate was 59% and the glucose yield was 31.2%. The cellulose conversion rate of about 1.8 times higher and the glucose yield of about 4.5 times higher than Referential Example 1, in which a solid catalyst was not added, were achieved. The cellulose conversion rate was 24% and the glucose yield was 8.3% in Comparative Example 3, in which a solid catalyst and 1.4 mN of Na₂SO₄ were added, and the cellulose conversion rate and the glucose yield decreased to the relative ratio of 40% and 24%, respectively, to those of Referential Example 2, in which Na₂SO₄ was not added. However, the decrease rate was relatively lower compared to Comparative Example 1, in which a solid catalyst was not added.

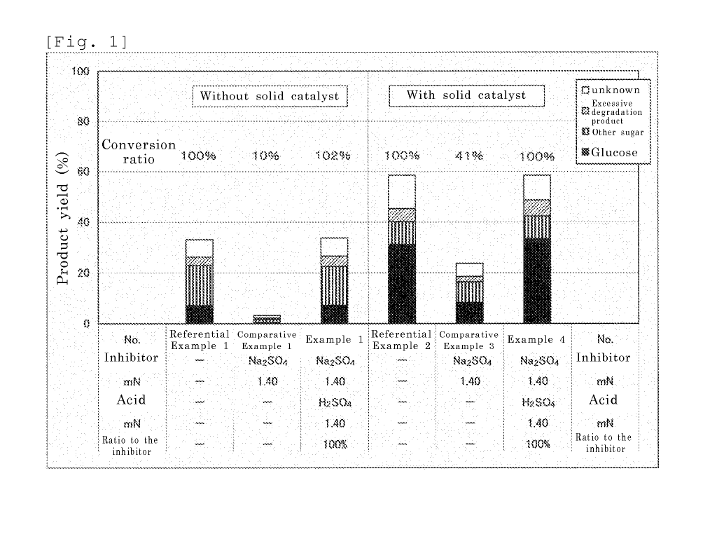

The inhibition of saccharification was completely eliminated by adding sulfuric acid in a mol concentration of 100% of the inhibitor (Example 1, Example 4) (FIG. 1).

In the case where Na₂SO₄ (Comparative Examples 3 to 6) or (NH₄)₂SO₄ (Comparative Examples 7 to 9) was added, the conversion rate and the glucose yield decreased in any of the cases. Thus, it was confirmed that the inhibition of the hydrolysis was caused by cations other than Nat.

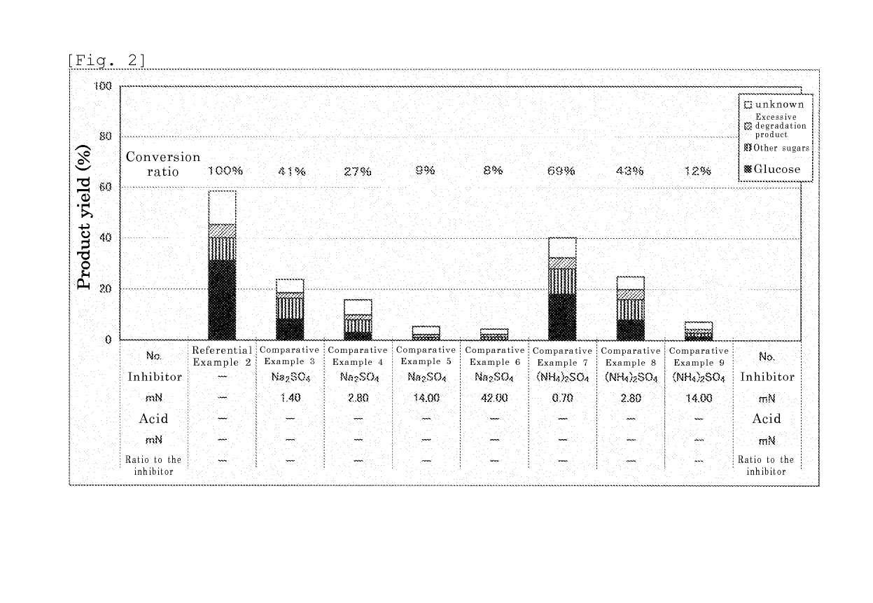

The degree of inhibition varies depending on the kind of cations and the concentration of cations to be added. Regarding the kind of cations, Na cations have greater inhibitory influence than ammonium ions. With a higher concentration of cations to be added, the cations have greater inhibitory influence, and when the concentration exceeds about 10 mN, the degree of hydrolysis was suppressed to 20% or lower in both cases where the cations were Na ions or ammonium ions (FIG. 2).

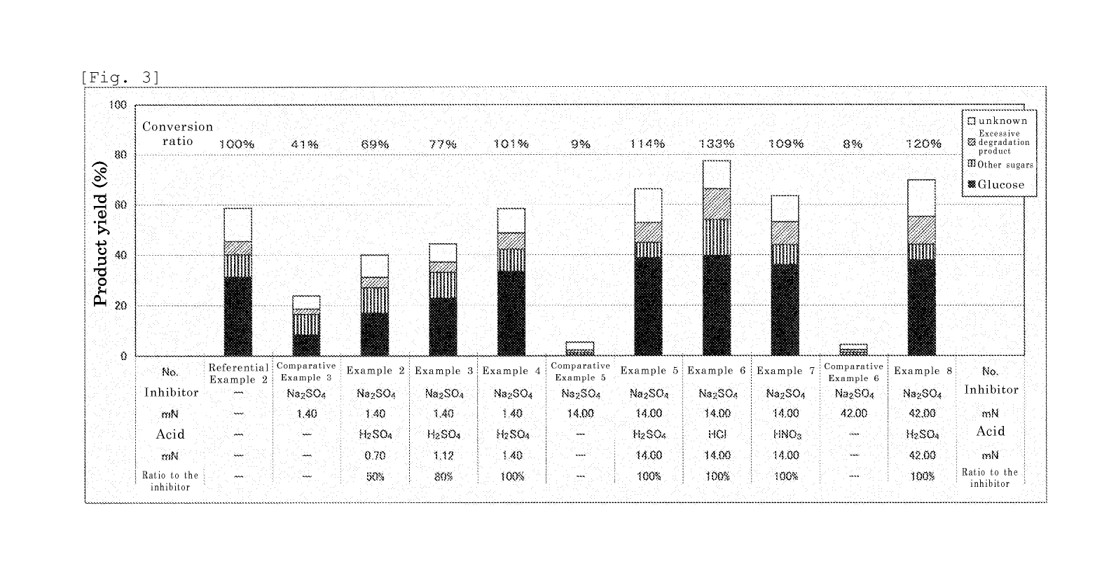

With respect to the addition of acid to eliminate the inhibition of hydrolysis due to Na₂SO₄, sulfuric acid was added to the solution containing 1.4 mN of Na₂SO₄. The degree of hydrolysis was improved when sulfuric acid equal to 50% (Example 2) or 80% (Example 3) of the equivalent concentration of Na₂SO₄ wad added but did not recover to the level of the case where neither of an inhibitor nor acid was added (Referential Example 2). When the sulfuric acid equal to 100% of the equivalent concentration of Na₂SO₄ was added (Example 4), the degree of hydrolysis was completely recovered. When Na₂SO₄ was increased to 14 mN or 42 mN, it was also confirmed that the inhibition of hydrolysis was eliminated to the level of the case where neither of an inhibitor nor acid is added (Referential Example 2) by adding acid (sulfuric acid, hydrochloric acid or nitric acid) equal to 100% of the equivalent concentration of Na₂SO₄ (Examples 5 to 7). With respect to the pH, the value after the addition of acid and the value after the reaction were the same in any of the cases: i.e. pH 2.9 when Na₂SO₄ was 1.4 mN (Example 4), pH 2.0 when Na₂SO₄ was 14 mN (Example 5 to 7), and pH 1.7 when Na₂SO₄ was 42 mN (Example 8). The pH value varies depending on the addition amount of acid, and it was confirmed that the condition of the addition of acid in order to recover the saccharification to the similar level in the case where neither of an inhibitor nor acid is added does not depend on the pH after the addition of acid but on the Na⁺ concentration. Also, in any of the cases of using sulfuric acid, hydrochloric acid and nitric acid, the inhibition of the hydrolysis was completely eliminated if acid equal to 100% of the equivalent concentration of Na₂SO₄ was added (Examples 4 to 8). The hydrolysis performance at this time varied a little according to the kind of acid, and with respect to both of the cellulose conversion rate and the glucose yield, the acids were ranked in descending order as follows: hydrochloric acid>sulfuric acid>nitric acid (Table 2 and FIG. 3).

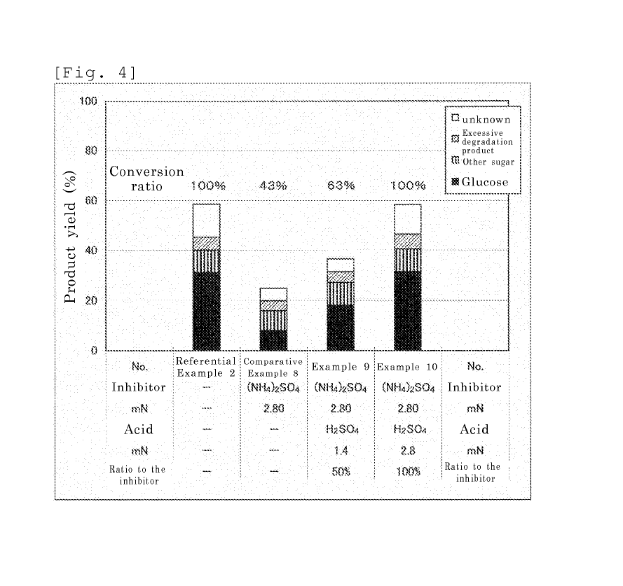

With respect to the addition of sulfuric acid to eliminate the inhibition due to (NH₄)₂SO₄, the degree of hydrolysis was improved when sulfuric acid equal to 50% (Example 9) of the equivalent concentration of (NH₄)₂SO₄ was added but did not recover to the level of the case where neither of an inhibitor nor acid was added (Referential Example 2). When the sulfuric acid equal to 100% of the equivalent concentration of (NH₄)₂SO₄ was added (Example 10), the degree of hydrolysis was completely recovered and a result similar to that of the case using Na₂SO₄ was shown (FIG. 4).

TABLE 2

| | | | Ref. | Comp. | Comp. | | | | Comp. |
|---|---|---|---|---|---|---|---|---|---|
| | | | Ex. 2 | Ex. 2 | Ex. 3 | Ex. 2 | Ex. 3 | Ex. 4 | Ex. 4 |
| Conditions | Inhibitor | Kind | — | Na₂SO₄ | Na₂SO₄ | Na₂SO₄ | Na₂SO₄ | Na₂SO₄ | Na₂SO₄ |
| | | Concentration | — | 0.7 | 1.4 | 1.4 | 1.4 | 1.4 | 2.8 |
| | | (mN) | | | | | | | |
| | Acid | Kind | — | — | — | H₂SO₄ | H₂SO₄ | H₂SO₄ | — |
| | | Concentration | — | — | — | 0.7 | 1.1 | 1.4 | — |
| | | (mN) | | | | | | | |
| | | Relative ratio to | — | — | — | 50 | 80 | 100 | — |
| | | the concentration | | | | | | | |
| | | of | | | | | | | |
| | | inhibitor (%) (a) | | | | | | | |
| Results | pH | Before the | 4.2 | 4.1 | 4.1 | 4.1 | 4.1 | 4.1 | 4.3 |
| | | addition of acid | | | | | | | |
| | | After the | — | — | — | 3.2 | 3.0 | 2.9 | — |
| | | addition of acid | | | | | | | |
| | | After the | 3.3 | 3.1 | 3.2 | 3.1 | 3.0 | 2.9 | 3.1 |
| | | reaction | | | | | | | |
| | Product | Glucose | 31.2 | 13.4 | 8.3 | 16.9 | 22.8 | 33.4 | 3.1 |
| | yield (%, | Other sugars (b) | 8.9 | 7.9 | 8.1 | 10.1 | 10.3 | 8.9 | 4.9 |
| | on the | Excessive | 5.2 | 3.1 | 2.1 | 4.1 | 4.0 | 6.4 | 1.9 |
| | basis of | degradation | | | | | | | |
| | carbon) | product (c) | | | | | | | |
| | | Unknown | 13.2 | 5.7 | 5.3 | 8.9 | 7.3 | 9.7 | 5.9 |
| | Rate of cellulose conversion | | 59 | 30 | 24 | 40 | 44 | 58 | 16 |
| | (%) | | | | | | | | |
| | Selectivity of glucose (%) | | 53 | 45 | 35 | 42 | 51 | 57 | 20 |
| | Relative | Glucose yield | 100 | 43 | 27 | 54 | 73 | 107 | 10 |
| | ratio to | Rate of | 100 | 51 | 41 | 68 | 76 | 100 | 27 |
| | Referential | cellulose | | | | | | | |
| | Example 1 | conversion | | | | | | | |
| | (%) | Selectivity of | 100 | 83 | 65 | 79 | 96 | 107 | 37 |
| | | glucose | | | | | | | |

| | | | Comp. | | | | Comp. | |
|---|---|---|---|---|---|---|---|---|
| | | | Ex. 5 | Ex. 5 | Ex. 6 | Ex. 7 | Ex. 6 | Ex. 8 |
| Conditions | Inhibitor | Kind | Na₂SO₄ | Na₂SO₄ | Na₂SO₄ | Na₂SO₄ | Na₂SO₄ | Na₂SO₄ |
| | | Concentration | 14.0 | 14.0 | 14.0 | 14.0 | 42.0 | 42.0 |
| | | (mN) | | | | | | |
| | Acid | Kind | — | H₂SO₄ | HCl | HNO₃ | — | H₂SO₄ |
| | | Concentration | — | 14.0 | 14.0 | 14.0 | — | 42.0 |
| | | (mN) | | | | | | |
| | | Relative ratio to | — | 100 | 100 | 100 | — | 100 |
| | | the concentration | | | | | | |
| | | of | | | | | | |
| | | inhibitor (%) (a) | | | | | | |
| Results | pH | Before the | 4.3 | 4.3 | 4.3 | 4.3 | 4.3 | 4.3 |
| | | addition of acid | | | | | | |
| | | After the | — | 2.0 | 2.0 | 2.0 | — | 1.7 |
| | | addition of acid | | | | | | |
| | | After the | 3.3 | 2.0 | 2.0 | 2.0 | 3.3 | 1.7 |
| | | reaction | | | | | | |
| | Product | Glucose | 0.3 | 38.8 | 39.7 | 36.1 | 0.3 | 37.9 |
| | yield (%, | Other sugars (b) | 0.9 | 6.1 | 14.3 | 7.9 | 1.1 | 6.2 |
| | on the | Excessive | 1.1 | 7.9 | 12.2 | 9.1 | 1.0 | 11.1 |
| | basis of | degradation | | | | | | |
| | carbon) | product (c) | | | | | | |
| | | Unknown | 3.1 | 13.4 | 11.2 | 10.3 | 2.1 | 14.6 |
| | Rate of cellulose conversion | | 5 | 66 | 77 | 63 | 4 | 70 |
| | (%) | | | | | | | |
| | Selectivity of glucose (%) | | 6 | 59 | 51 | 57 | 6 | 54 |
| | Relative | Glucose yield | 1 | 124 | 127 | 116 | 1 | 121 |
| | ratio to | Rate of | 9 | 113 | 132 | 108 | 8 | 119 |
| | Referential | cellulose | | | | | | |
| | Example 1 | conversion | | | | | | |
| | (%) | Selectivity of | 10 | 110 | 96 | 107 | 11 | 102 |
| | | glucose | | | | | | |

(a) Concentration of inorganic acid: {(mN)/concentration of the inhibitor (mN)} × 100
(b) Total of cellobiose, cellotriose, mannose and fructose
(c) Total of levoglucosan, 5-hydroxymethylfurfural and levoglucosan

TABLE 3

| | | | Comp. | Comp. | | | Comp. |
|---|---|---|---|---|---|---|---|
| | | | Ex. 7 | Ex. 8 | Ex. 9 | Ex. 10 | Ex. 9 |
| Conditions | Inhibitor | Kind | (NH₄)₂SO₄ | (NH₄)₂SO₄ | (NH₄)₂SO₄ | (NH₄)₂SO₄ | (NH₄)₂SO₄ |
| | | Concentration | 0.7 | 2.8 | 2.8 | 2.8 | 14.0 |
| | | (mN) | | | | | |
| | Acid | Kind | — | — | H₂SO₄ | H₂SO₄ | — |
| | | Concentration | — | — | 1.4 | 2.8 | — |
| | | (mN) | | | | | |
| | | Relative ratio to | — | — | 50 | 100 | — |
| | | the concentration | | | | | |
| | | of | | | | | |
| | | inhibitor (%) (a) | | | | | |
| Results | pH | Before the | 4.2 | 4.2 | 4.2 | 4.2 | 4.2 |
| | | addition of acid | | | | | |
| | | After the | — | — | 2.9 | 2.8 | — |
| | | addition of acid | | | | | |
| | | After the | 3.3 | 3.4 | 2.9 | 2.8 | 3.4 |
| | | reaction | | | | | |
| | Product yield | Glucose | 18.0 | 8.0 | 18.1 | 31.4 | 1.5 |
| | (%, on the basis | Other sugars (b) | 10.0 | 7.9 | 9.1 | 9.1 | 1.4 |
| | of carbon) | Excessive | 4.3 | 4.0 | 4.2 | 5.9 | 1.4 |
| | | degradation | | | | | |
| | | product (c) | | | | | |
| | | Unknown | 7.9 | 5.1 | 5.2 | 11.8 | 2.9 |
| | Rate of cellulose conversion (%) | | 40 | 25 | 37 | 58 | 7 |
| | Selectivity of glucose (%) | | 45 | 32 | 49 | 54 | 21 |
| | Relative ratio to | Glucose yield | 58 | 26 | 58 | 101 | 5 |
| | Referential | Rate of | 69 | 43 | 63 | 99 | 12 |
| | Example 2 (%) | cellulose | | | | | |
| | | conversion | | | | | |
| | | Selectivity of | 84 | 60 | 93 | 101 | 39 |
| | | glucose | | | | | |

(a) Concentration of inorganic acid: {(mN)/concentration of the inhibitor (mN)} × 100
(b) Total of cellobiose, cellotriose, mannose and fructose
(c) Total of levoglucosan, 5-hydroxymethylfurfural and levoglucosan

### INDUSTRIAL APPLICABILITY

According to the present invention, a high glucose yield can be obtained by eliminating a reaction-inhibiting factor by a simple method of allowing acid to coexist according to the equivalent concentration of cations in the reaction solution in a hydrolysis reaction by a hydrothermal treatment of a plant biomass.

1. A method for hydrolyzing a plant biomass, comprising hydrothermal treatment in the presence of an equivalent concentration of an acid equal to 30 to 1,000% of the equivalent concentration of cations in a plant-biomass hydrolysis reaction solution.

2. The method for hydrolyzing a plant biomass according to claim 1, wherein a solid catalyst is used in the hydrothermal treatment.

3. The method for hydrolyzing a plant biomass according to claim 1, wherein the acid is at least one member selected from inorganic mineral acid, organic carbonic acid and organic sulfonic acid.

4. The method for hydrolyzing a plant biomass according to claim 1, wherein the cation in the reaction solution is at least one member selected from alkali metal ion, alkaline earth metal ion and ammonium ion.

5. The method for hydrolyzing a plant biomass according to claim 1, wherein the equivalent concentration of the acid is 100 to 300% of the equivalent concentration of cations in a plant-biomass hydrolysis reaction solution.

6. The method for hydrolyzing a plant biomass according to claim 2, wherein the solid catalyst is a carbon material.

7. The method for hydrolyzing a plant biomass according to claim 3, wherein the inorganic mineral acid is at least one member selected from hydrochloric acid, sulfuric acid, nitric acid, phosphoric acid and boric acid.

8. The method for hydrolyzing a plant biomass according to claim 1, wherein the cation in the reaction solution is at least one member selected from Na⁺, K⁺, Mg²⁺, Ca²⁺ and NH₄⁺.

9. The method for hydrolyzing a plant biomass according to claim 1, wherein the plant biomass is cellulose.

10. A method for producing glucose, characterized in using the method for hydrolyzing a plant biomass claimed in claim 1.
